(19) United States
(12) Patent Application Publication
(10) Pub. No.: US 2007/0109252 A1
(43) Pub. Date: May 17, 2007

(54) METHODS AND DEVICES FOR DRIVING A DISPLAY BACKLIGHT, AND DISPLAY APPARATUS HAVING A BACKLIGHT DRIVING DEVICE

(75) Inventors: Seong-Sik Shin, Seongnam-si, Gyeonggi-do (KR); Sang-Gil Lee, Seoul (KR); Hyeon-Yong Jang, Osan-si, Gyeonggi-do (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/561,193

(22) Filed: Nov. 17, 2006

(30) Foreign Application Priority Data
Nov. 17, 2005 (KR) 10-2005-0109946

(51) Int. Cl. G09G 3/36

(52) U.S. Cl. 345/102

(57) ABSTRACT

A device for driving a display backlight, a method for driving a display backlight, and a display apparatus having a backlight driving device. The device, method, and display apparatus are capable of displaying a substantially uniform white light. A sensing unit senses light intensities for each of a plurality of colors of light emitted by the light emitting elements, and outputs sensing signals for each of the plurality of colors of light emitted by the light emitting elements. The signal processing unit processes the outputted sensing signals to output light intensity signals for each of the plurality of colors of light emitted by the light emitting elements. The control unit controls the light emitting elements to generate a substantially uniform white light by outputting driving signals based on the light intensity signals and a set of reference light intensity signals to control each of the plurality of colors of light emitted by the light emitting elements. Accordingly, increased uniformity of white light is provided.

This application claims priority to Korean Patent Application No. 2005-109946 filed on Nov. 17, 2005 and all the benefits accruing therefrom under 35 USC §119, the entire contents of which are incorporated herein by reference.

### BACKGROUND OF THE INVENTION

1. Field of the Invention

The present invention relates to electronic display devices. More particularly, the present invention relates to a device and method for driving a display backlight, as well as a display apparatus having a backlight driving device.

2. Description of the Related Art

Generally, liquid crystal displays (LCDs) are categorized as either reflective LCD panels or transmissive LCD panels. Reflective LCD panels display images using light that is incident on a front face of the panel which is then reflected by a rear face of the panel. Transmissive LCD panels display images using a transmitted light that is incident on a rear face of the panel and then transmitted through the panel. In accordance with the ambient environment, a reflective LCD panel may not receive a sufficient amount of incident light, and/or the incident light may not be uniform, thus providing a display having poor visibility. Accordingly, transmissive LCD panels having color filters are generally employed in applications where color display is required. Transmissive LCD panels provide a light transmission rate of about 4%, thus requiring use of a very bright light in order to achieve bright images. Accordingly, transmissive LCD panels may have increased power consumption due to display backlighting requirements. In addition, if the transmissive LCD panel uses color filters, then each pixel of the LCD panel contains sub-pixels as, for example, a red sub-pixel, a green sub-pixel and a blue sub-pixel. Thus, it may be difficult to manufacture the transmissive LCD panel to a required level of precision, and the resulting panel may not exhibit sufficient color purity.

In order to solve the aforementioned shortcomings of transmissive LCD panels, field sequential color LCD panels have been developed. The field sequential color LCD panel operates in conjunction with a backlight having a red light source, a green light source and a blue light source. These color light sources are driven in a temporally offset manner to display color images. Field sequential color LCD panels do not use color filters and, therefore, only utilize colors of light as directly emitted by the color light sources. Thus, field sequential color LCD panels may provide good color purity and decreased power consumption due to their highly efficient utilization of light.

However, field sequential color LCD panels do not display a substantially uniform white light because a red light, a green light and a blue light are not simultaneously projected from the red, green and blue light sources, but rather these sources are driven in a temporally offset manner. Accordingly, what is needed is a device and a method for displaying substantially uniform white light on an LCD panel.

### SUMMARY OF THE INVENTION

Exemplary embodiments of the present invention provide a device for driving a display backlight wherein the device is capable of generating a substantially uniform white light.

Exemplary embodiments of the present invention provide a method for driving a display backlight capable of generating a substantially uniform white light.

Exemplary embodiments of the present invention provide a display apparatus having a backlight driving device capable of displaying a substantially uniform white light.

Further exemplary embodiments provide a backlight driving device for driving a display backlight. The backlight driving device sequentially drives each of a plurality of light emitting elements included in the backlight in accordance with one or more colors of light to be displayed. The backlight driving device includes a sensing unit, a signal processing unit and a control unit. The sensing unit senses light intensities for each of a plurality of colors of the light emitted by the light emitting elements and outputs sensing signals for each of the plurality of colors of light emitted by the light emitting elements. The signal processing unit processes the outputted sensing signals to output light intensity signals for each of the plurality of colors of light emitted by the light emitting elements. The control unit controls the light emitting elements to generate a substantially uniform white light by outputting driving signals to the light emitting elements for each of the plurality of colors of light emitted by the light emitting elements. The driving signals are based on at least one of the light intensity signals and a set of reference light intensity signals. Illustratively, the set of reference light intensity signals may be pre-stored in accordance with the colors emitted by the light emitting elements provided in the control unit.

Further embodiments provide a method for driving a display backlight in which each of a plurality of light emitting elements included in the backlight are sequentially driven in accordance with one or more colors of light to be displayed. Light intensities are sensed for each of a plurality of colors emitted by the light emitting elements to output sensing signals for each of the plurality of colors emitted by the light emitting elements. The outputted sensing signals are processed to output light intensity signals for each of the plurality of colors of light emitted by the light emitting elements. The light emitting elements are controlled to generate a uniform white light using at least one of the light intensity signals and a set of reference light intensity signals that may be pre-stored in accordance with the colors emitted by the light emitting elements provided in the control unit.

Further embodiments provide a display apparatus that includes an LCD display panel, a display backlight and a backlight driving device for driving the display backlight. The LCD display panel displays an image. The display backlight includes a plurality of light emitting elements for projecting color light to the LCD display panel. The backlight driving device sequentially drives the plurality of light emitting elements to display at least one color of light. The backlight driving device detects light intensities for each of a plurality of colors of light emitted by the light emitting elements and uses the detected light intensities to control the light emitting elements so that the light emitting elements will generate a uniform white light.

According to illustrative embodiments, in a display apparatus that sequentially projects color lights into a display panel, the uniformity of the white light displayed by the panel may be enhanced.

### BRIEF DESCRIPTION OF THE DRAWINGS

The above and other features and advantages of the present invention will become more apparent by describing exemplary embodiments thereof with reference to the accompanying drawings, in which:

FIG. 1 is a block diagram of an exemplary display apparatus in accordance with an exemplary embodiment of the present invention;

FIG. 2 is a perspective view showing an illustrative display backlight for use with the display apparatus of FIG. 1;

FIG. 3 is a timing diagram showing an illustrative method for driving the display apparatus of FIG. 1;

FIG. 4 is a detailed block diagram showing an illustrative backlight driving device for use with the display apparatus of FIG. 1;

FIG. 5 is a detailed block diagram setting forth illustrative implementations for each of a plurality of block drivers shown in FIG. 4 in accordance with exemplary embodiments of the present invention;

FIG. 6 is an exemplary timing diagram illustrating an operational sequence performed by the block drivers shown in FIG. 5;

FIGS. 7A to 7C are timing diagrams showing exemplary first, second and third pulse signals for use with the illustrative configuration of FIG. 5;

FIG. 8 is a detailed block diagram showing exemplary implementations for each block driver of FIG. 4 in accordance with exemplary embodiments of the present invention; and

FIG. 9 is a timing diagram illustrating an exemplary operation performed by the block driver of FIG. 8.

### DETAILED DESCRIPTION OF THE INVENTION

The invention now will be described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element or layer is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” or “includes” and/or “including”, when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the invention. As such, variations from the shapes of the illustrations as a result, for example, of manufacturing techniques and/or tolerances, are to be expected. Thus, exemplary embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from an implanted region to a non-implanted region. Likewise, a buried region formed by implantation may result in some implantation in the region between the buried region and the surface through which the implantation takes place. Thus, the regions illustrated in the figures are schematic in nature, and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the present invention will be explained in detail with reference to the accompanying drawings.

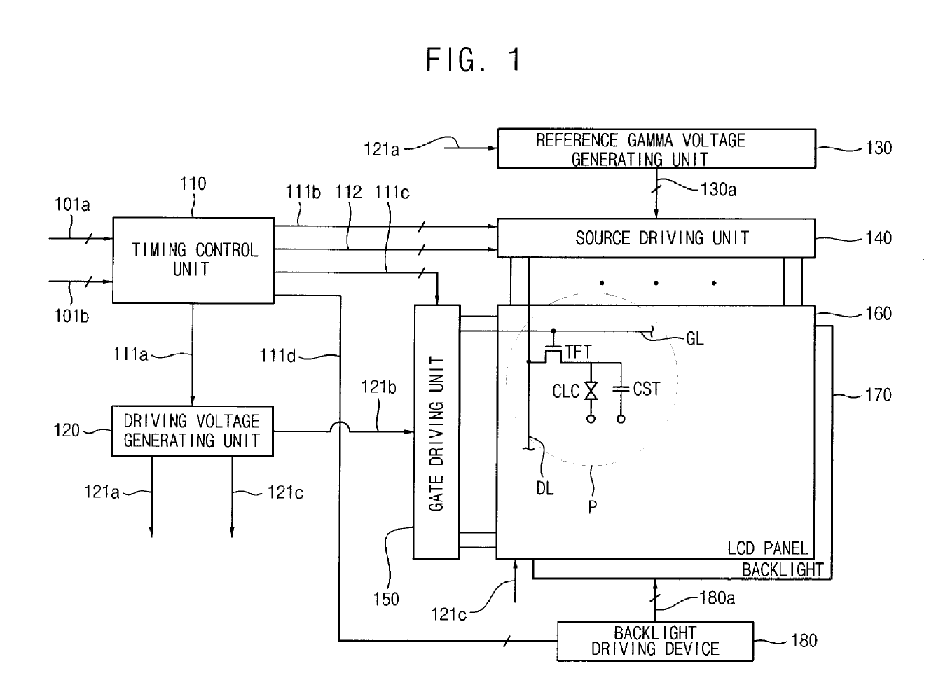

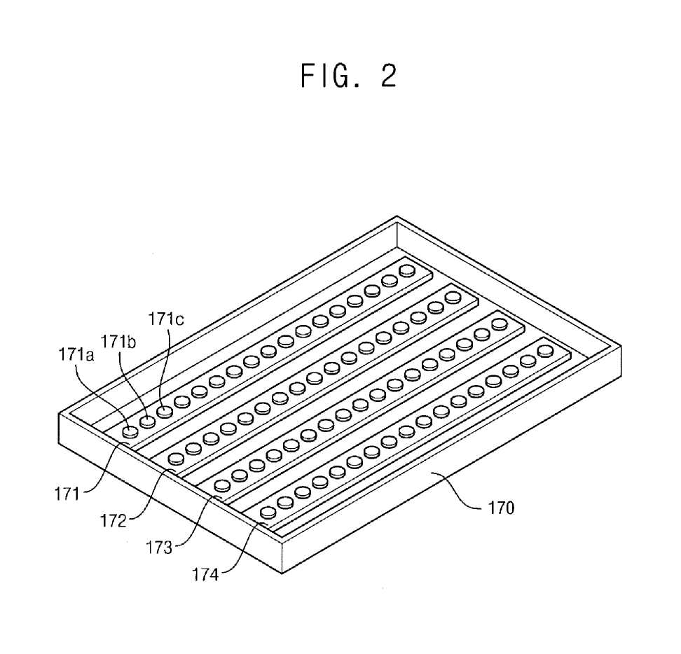

FIG. 1 is a block diagram of an exemplary display apparatus in accordance with an exemplary embodiment of the present invention, and FIG. 2 is a perspective view illustrating an exemplary display backlight for use with the display apparatus of FIG. 1. The exemplary display apparatus includes a timing control unit 110 (FIG. 1), a driving voltage generating unit 120, a reference gamma voltage generating unit 130, a source driving unit 140, a gate driving unit 150, an LCD panel 160, a backlight 170 (FIGS. 1 and 2) and a backlight driving device 180 (FIG. 1). A control signal 101a and a data signal 101b (FIG. 1) are inputted into the timing control unit 110. The timing control unit 110 generates and outputs control signals for driving the display apparatus using the control signal 101a. Illustratively, the control signals outputted from the timing control unit 110 include a first control signal 111a controlling the driving voltage generating unit 120, a second control signal 111b controlling the source driving unit 140, a third control signal 111c controlling the gate driving unit 150, and a fourth control signal 111d controlling the backlight driving device 180.

Illustratively, the first control signal 111a includes a main clock signal. The second control signal 111b includes a horizontal start signal, a load signal and a reversal signal. The third control signal 111c includes a vertical start signal and a clock signal. The fourth control signal 111d includes a dimming signal that is a brightness control signal, and a lighting signal that is a lighting control signal.

The driving voltage generating unit 120 generates driving voltages for driving the display apparatus. Illustratively, the driving voltage generating unit 120 outputs an analog driving voltage 121a to the reference gamma voltage generating unit 130, outputs gate voltages 121b to the gate driving unit 150, and outputs a common voltage 121c to the LCD panel 160.

The reference gamma voltage generating unit 130 generates and outputs a plurality of reference gamma voltages, wherein this plurality illustratively includes about 10 to 20 different reference gamma voltages 130a generated using the analog driving voltage 121a to the source driving unit 140.

The source driving unit 140 transforms a data signal 112 inputted from the timing control unit 110 into a data voltage. The source driving unit then outputs the data voltage. Illustratively, the source driving unit 140 transforms the data signal 112 into an analog data voltage using the second control signal 111b and the reference gamma voltages 130a, and outputs the analog data voltage to the LCD panel 160.

The gate driving unit 150 generates gate signals using the third control signal 111c supplied by the timing control unit 110, as well as the gate voltages 121b supplied by the driving voltage generating unit 120, and outputs the generated gate signals to the LCD panel 160.

The LCD panel 160 has a first substrate including a plurality of pixel parts P defined with reference to a plurality of gate lines GL and a plurality of data lines DL, a second substrate facing the first substrate, and a liquid crystal interposed between the first and second substrates. The second substrate does not have any color filter pattern corresponding to the pixel part P formed in the first substrate.

Each pixel part P formed in the LCD panel 160 includes a switching element TFT connected to the gate line GL and the data line DL, a liquid capacitor CLC having a first terminal and a second terminal wherein the first terminal is connected to the switching element TFT, and a storage capacitor CST having a first terminal and a second terminal wherein the first terminal is connected to the switching element TFT. The common voltage 121c supplied by the driving voltage generating unit 120 is applied to the second terminal of the liquid capacitor CLC and to the second terminal of the storage capacitor CST.

Referring now to FIG. 2, the backlight 170 has a plurality of blocks 171, 172, 173 and 174, which are sequentially driven using one or more predetermined time offsets. Illustratively, the backlight 170 has four blocks or eight blocks.

Illustratively, a first block 171 contains a plurality of light emitting elements including a first light emitting element 171a emitting a first light, a second light emitting element 171b emitting a second light, and a third light emitting element 171c emitting a third light. The first, second and third light emitting elements 171a, 171b and 171c are driven using one or more predetermined time offsets to thereby sequentially generate the first, second and third lights, respectively.

The backlight driving device 180 drives the backlight 170 using the dimming signal and the lighting signal, which are obtained from the fourth control signal 111d, supplied by the timing control unit 110. Additionally, the backlight driving unit 180 senses light intensities of the first, second and third lights projected from the backlight 170, and corrects any errors of the sensed light intensities to control the backlight 170 so that a substantially uniform white light may be projected from the backlight 170.

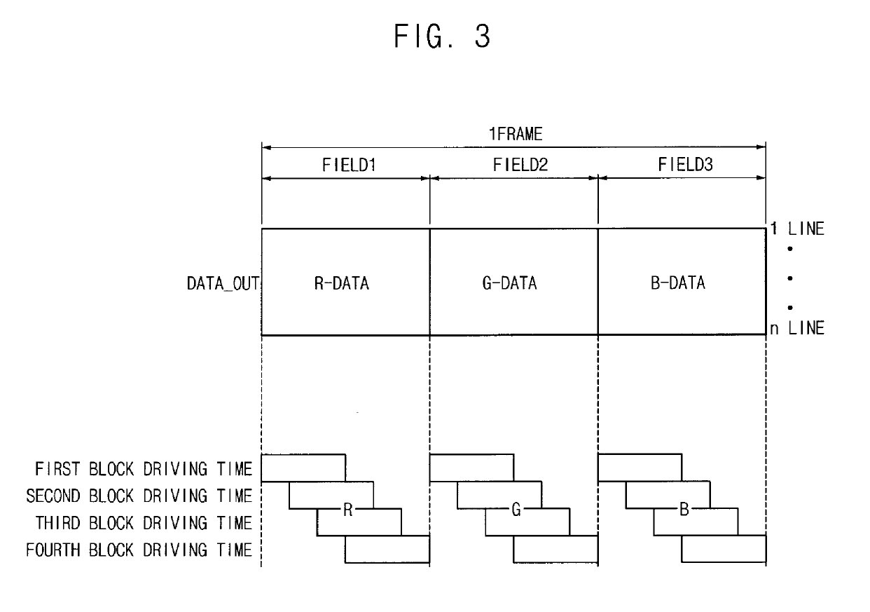

FIG. 3 is a timing diagram illustrating a method for driving the display apparatus shown in FIG. 1. Referring to FIGS. 1 and 3, the display apparatus is driven using time frames, each of which is organized into a plurality of fields. For example, the timing control unit 110 drives the source driving unit 140, the gate driving unit 150 and the backlight device 180 according to time frames each of which is organized into a first field FIELD1, a second field FIELD2 and a third field FIELD3.

The source driving unit 140 outputs a red data signal R-DATA corresponding to a first time frame 1FRAME to the LCD panel 160 during the first field FIELD1. When the red data signal R-DATA for the first time frame 1FRAME is outputted to the LCD panel 160, the backlight driving device 180 is synchronized with the first field FIELD1 to drive the first light emitting elements 171a of the backlight 170 during at least a portion of the first field FIELD1. Thus, while the red data signal R-DATA is outputted, the backlight 170 projects a red color light to the LCD panel 160 so that a red image may be displayed in the LCD panel 160.

The source driving unit 140 outputs a green data signal G-DATA corresponding to the first time frame 1FRAME to the LCD panel 160 during the second field FIELD2. When the green data signal G-DATA of the first time frame 1FRAME is outputted to the LCD panel 160, the backlight driving device 180 is synchronized with the second field FIELD2 to drive the second light emitting elements 171b of the backlight 170 during at least a portion of the second field FIELD2. Thus, while the green data signal G-DATA is outputted, the backlight 170 projects a green color light to the LCD panel 160 so that a green image may be displayed in the LCD panel 160.

The source driving unit 140 outputs a blue data signal B-DATA corresponding to the first time frame 1FRAME to the LCD panel 160 during the third field FIELD3. When the blue data signal B-DATA of the first time frame 1FRAME is outputted to the LCD panel 160, the backlight driving device 180 is synchronized with the third field FIELD3 to drive the third light emitting elements 171c of the backlight 170 during at least a portion of the third field FIELD3. Thus, while the blue data signal B-DATA is outputted, the backlight 170 projects a blue color light to the LCD panel 160 so that a blue image may be displayed in the LCD panel 160.

As a result, the red, the green and the blue images are displayed during a single frame, such as the first time frame 1FRAME, so that color images may be displayed without forming a first single color (i.e., red) color pattern in a first frame, followed by a second single color (i.e., green) color pattern in a second frame, and a third single color (i.e., blue) color pattern in a third frame.

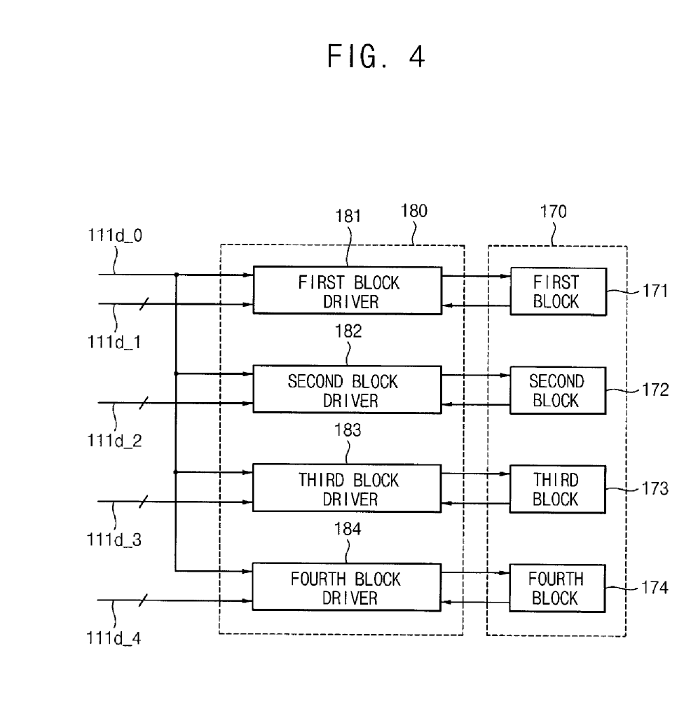

FIG. 4 is a detailed block diagram of the backlight driving device shown in FIG. 1. Referring to FIGS. 1 and 4, the backlight driving device 180 includes a plurality of block drivers for driving the backlight 170. For example, when the backlight 170 includes a first block 171, a second block 172, a third block 173 and a fourth block 174, the backlight driving device 180 includes a first block driver 181, a second block driver 182, a third block driver 183 and a fourth block driver 184 driving the first, second, third and the fourth blocks 171, 172, 173 and 174, respectively.

A dimming signal 111d _0, that may be conceptualized as a brightness control signal, is inputted into the first, second, third and fourth block drivers 181, 182, 183 and 184. In addition, a first lighting signal, a second lighting signal, a third lighting signal and a fourth lighting signal 111d _1, 111d 2, 111d _3 and 11d _4 are sequentially inputted into the first, second, third and fourth block drivers 181, 182, 183 and 184, respectively.

The first block driver 181 sequentially drives the first, second and third light emitting elements 171a, 171b and 171c of the first block 171 using the dimming signal 111d _0 and the first lighting signal 111d _1. Illustratively, the first block driver 181 drives the first block 171 by supplying a pulse width modulated source signal to the first block 171.

The first block driver 181 detects a first light intensity of a first light emitting element projected from the first block 171, generating a first light intensity signal in response thereto. The first block driver 181 also detects a second light intensity of a second light emitting element projected from the first block 171, generating a second light intensity signal in response thereto. Additionally, the first block driver 181 detects a third light intensity of a third light emitting element projected from the first block 171, generating a third light intensity signal in response thereto. The first block driver 181 compares the first light intensity signal with a first reference light intensity signal, the second light intensity signal with a second reference light intensity signal, and the third light intensity signal with a third reference light intensity signal. The first, second, and third reference light intensity signals corresponding to white chromaticity coordinates, such that the first block driver 181 calculates an error value for each of the first, second and third light intensity signals. Illustratively, the first block driver 181 modulates the pulse width of a source signal received from the first block 171 using the aforementioned error values, to thereby generate a pulse width modulated output signal. In this manner the first block 171 is controlled to produce, a uniform white light. Likewise, the second, third and fourth block drivers 182, 183 and 184 drive the second, third and fourth blocks 172, 173 and 174, respectively, so that the second, third and fourth blocks 172, 173 and 174 may project uniform white light.

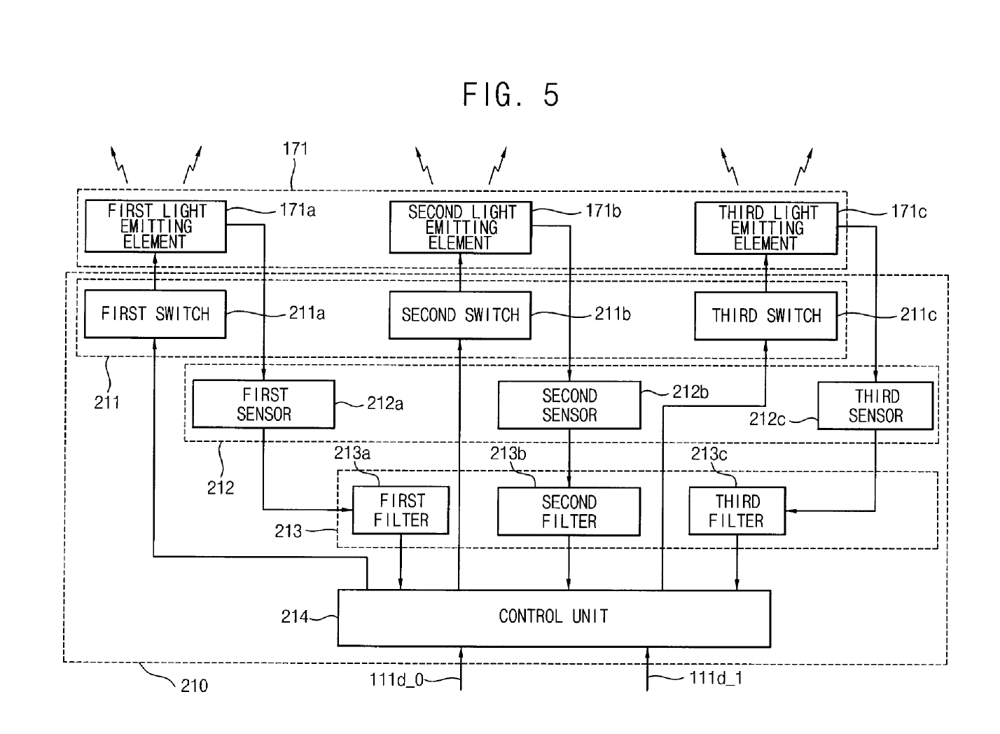

FIG. 5 is a detailed block diagram setting forth illustrative implementations for each of a plurality of block drivers shown in FIG. 4 in accordance with exemplary embodiment of the present invention. A block driver 210 drives the first block 171. The block driver 210 includes a switching unit 211, a sensing unit 212, a signal processing unit 213 and a control unit 214. For illustrative purposes, the first block 171 includes a first light emitting element 171a, a second light emitting element 171b, and a third light emitting element 171c.

The switching unit 211 includes a first switch 211a, a second switch 211b and a third switch 211c. The first switch 211a controls a lighting time of the first light emitting element 171a in response to a first pulse signal, the second switch 211b controls a lighting time of the second light emitting element 171b in response to a second pulse signal, and the third switch 211c controls a lighting time of the third light emitting element 171c in response to a third pulse signal. Illustratively, he first, second and third pulse signals are provided in the form of pulse width modulated source signals.

The sensing unit 212 includes a first sensor 212a, a second sensor 212b and a third sensor 212c. The first sensor 212a detects a light intensity of the first light emitting element 171a and outputs a first sensing signal. The second sensor 212b detects a light intensity of the second light emitting element 171b and outputs a second sensing signal. The third sensor 212c detects a light intensity of the third light emitting element 171c and outputs a third sensing signal.

The signal processing unit 213 includes a first filter 213a, a second filter 213b and a third filter 213c. Illustratively, the first, second and third filters 213a, 213b and 213c include low pass filters for reducing or eliminating high frequency components. For example, the first filter 213a reduces or eliminates high-frequency components of the first sensing signal to output a first lowpass-filtered light intensity signal, the second filter 213b reduces or eliminates high-frequency components of the second sensing signal to output a second lowpass-filtered light intensity signal, and the third filter 213c reduces or eliminates high-frequency components of the third sensing signal to output a third lowpass-filtered light intensity signal.

The control unit 214 controls operation of the block driver 210 such that the block driver 210 operates in a driving mode or in a correction mode or both. In the driving mode, the control unit 214 supplies the first, second and third switches 211a, 211b and 211c with the first, second and third pulse signals to drive the first, second and third light emitting elements 171a, 171b and 171c. In the correction mode, the control unit 214 compares the first, second and third reference light intensity signals with the first, second and third lowpass-filtered light intensity signals outputted from the first, second and third filters 213a, 213b and 213c, respectively, to apply a correction by reducing, minimizing, or eliminating the aforementioned error values for the first, second and third light intensity signals. The control unit 214 generates a first corrected pulse signal, a second corrected pulse signal and a third corrected pulse signal corresponding to the first, second and third light intensity signals, respectively. Illustratively, he first, second and third reference light intensity signals are pre-stored in the control unit 214 in the form of data specifying white chromaticity coordinates. The first, second and third corrected pulse signals may be generated using source signals for which pulse widths are modulated in a manner so as to correct or minimize the aforementioned error values.

The first, second and third corrected pulse signals generated by the control unit 214 are supplied to the first, second and third switches 211a, 211b and 211c, respectively, to turn on the first, second and third switches 211a, 211b and 211c, respectively, so that the lighting times of the first, second and third light emitting elements 171a, 171b and 171c may be controlled. As a result, the first, second and third light emitting elements 171a, 171b and 171c are illuminated in response to the first, second and third corrected pulse signals to generate a substantially uniform white light.

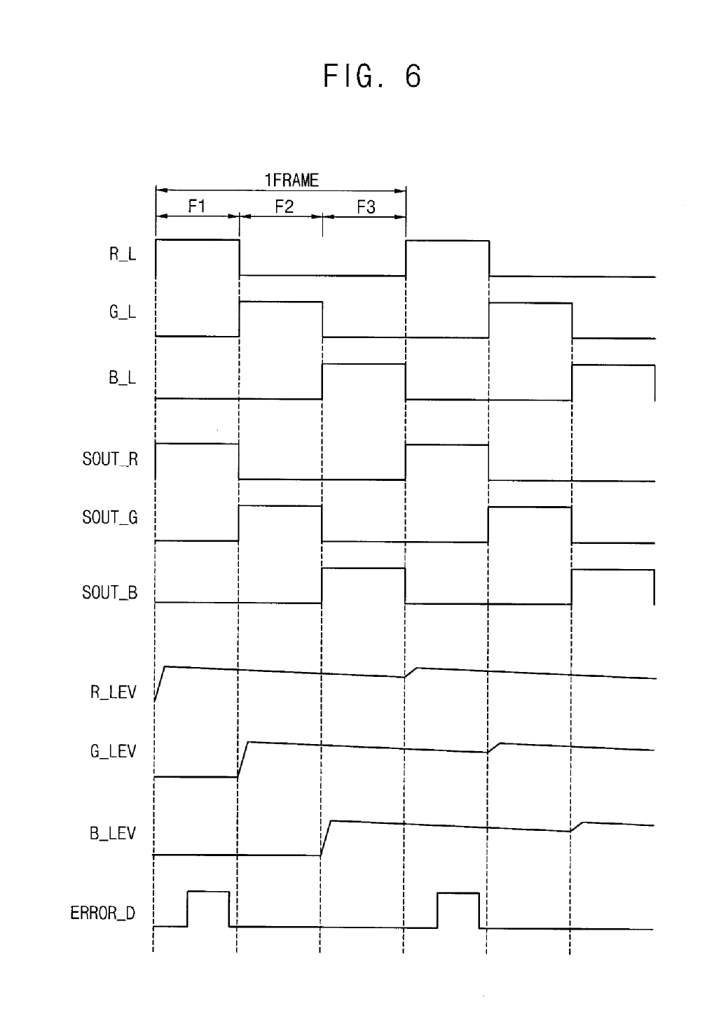

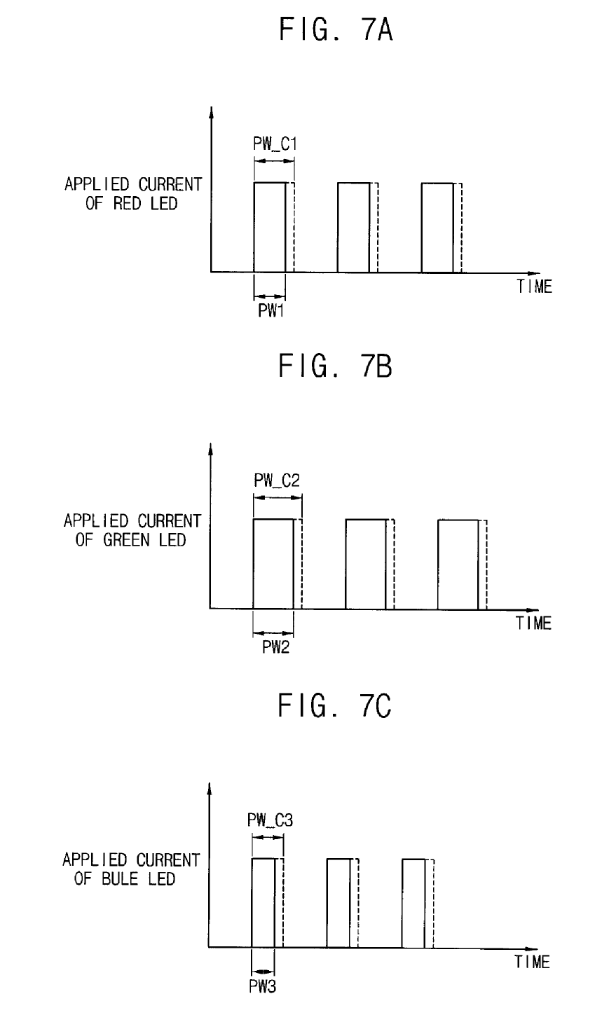

FIG. 6 is an exemplary timing diagram illustrating an operational sequence performed by the block drivers shown in FIG. 5. FIGS. 7A to 7C are timing diagrams showing exemplary first, second and third pulse signals for use with the illustrative configuration of FIG. 5. Referring to FIGS. 5, 6, and 7A to 7C, the control unit 214 (FIG. 5) supplies the first, second and third switches 211a, 211b and 211c with a first initial pulse signal PW1 (FIG. 7A), a second initial pulse signal PW2 (FIG. 7B) and a third initial pulse signal PW3 (FIG. 7C), respectively. The first, second and third switches 211a, 211b and 211c (FIG. 5) illuminate the first, second and third light emitting elements 171a, 171b and 171c in response to the first, second and third initial pulse signals PW1, PW2, and PW3, respectively. That is, the first light emitting element 171a projects a first light R_L (FIG. 6) during a first field F1, the second light emitting element 171b projects a second light G_L during a second field F2, and the third light emitting element 171c projects a third light B_L during a third field F3, per each time frame such as the first frame 1FRAME.

The first sensor 212a (FIG. 5) detects a light intensity of the first light R_L (FIG. 6) during the first field F1 to output a first sensing signal SOUT_R. The second sensor 212b (FIG. 5) detects a light intensity of the second light G_L (FIG. 6) during the second field F2 to output a second sensing signal SOUT_G. The third sensor 212c (FIG. 5) detects a light intensity of the third light B_L (FIG. 6) during the third field F3 to output a third sensing signal SOUT_B. Illustratively, first light R_L could, but need not, represent a red light. Similarly, second light G_L could, but need not, represent a green light, and third light B_L could, but need not, represent a blue light.

The first filter 213a (FIG. 5) reduces or eliminates high-frequency components of the first sensing signal SOUT_R (FIG. 6) to output a first lowpass-filtered light intensity signal R_Lev, the second filter 213b (FIG. 5) reduces or eliminates high-frequency components of the second sensing signal SOUT_G (FIG. 6) to output a second lowpass-filtered light intensity signal G_Lev, and the third filter 213c (FIG. 5) reduces or eliminates high-frequency components of the third sensing signal SOUT_B (FIG. 6) to output a third lowpass-filtered light intensity signal B_Lev.

The control unit 214 (FIG. 5) corrects any errors in the first, second and third lowpass-filtered light intensity signals R_Lev, G_Lev and B_Lev (FIG. 6) during an error detecting period ERROR_D. The control unit 214 (FIG. 5) compares the first, second and third light intensity signals R_Lev, G_Lev and B_Lev (FIG. 6) with the first, second and third reference light intensity signals, respectively, illustratively pre-stored in the control unit 214 (FIG. 5), to obtain a first error value, a second error value and a third error value for the first, second and third light intensity signals, respectively.

The control unit 214 (FIG. 5) generates a first corrected pulse signal PW_C1 (FIG. 7A), a second corrected pulse signal PW_C2 (FIG. 7B) and a third corrected pulse signal PW_C3 (FIG. 7C). The first corrected pulse signal PW_C1 (FIG. 7A) is generated using the first error value, the second corrected pulse signal PW_C2 (FIG. 7B) is generated using the second error value, and the third corrected pulse signal PW_C3 (FIG. 7C) is generated using the third error value. The first, second and third corrected pulse signals PW_C1, PW_C2 and PW_C3 (FIGS. 7A-7C) are fed to the first, second and third switches 211a, 211b and 211c (FIG. 5), respectively. Thus, the first, second and third light emitting elements 171a, 171b and 171c project substantially uniform white light in response to the first, second and third corrected pulse signals PW_C1, PW_C2 and PW_C3 (FIGS. 7A-7C).

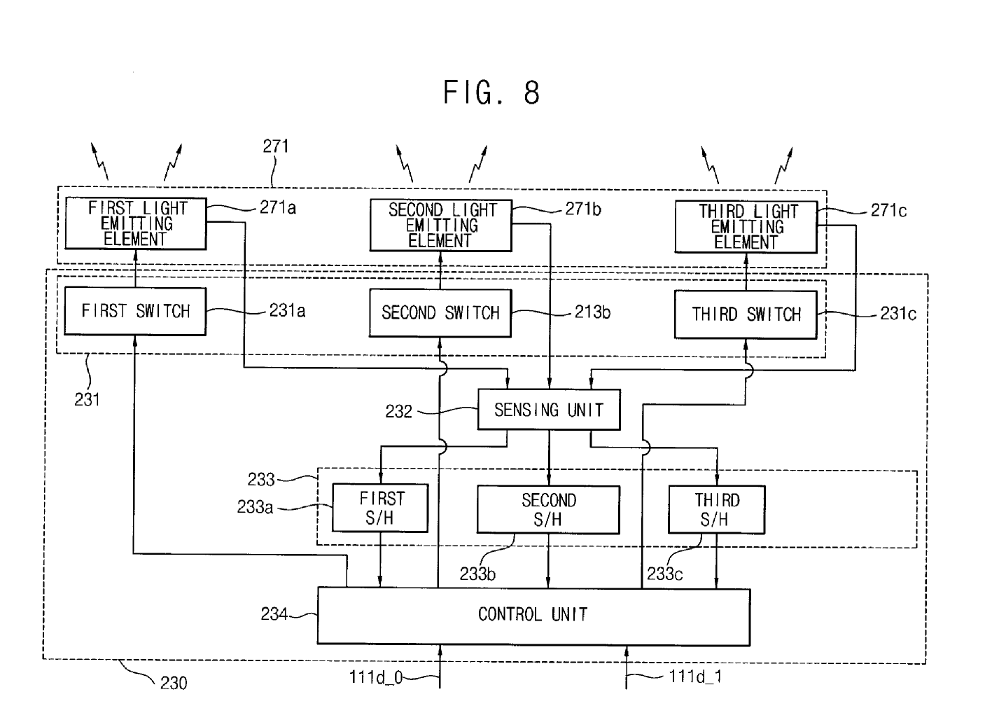

FIG. 8 is a detailed block diagram showing exemplary implementations for each block driver of FIG. 4 in accordance with exemplary embodiments of the present invention. A block driver 230 is utilized to drive a block 271. The block driver 230 includes a switching unit 231, a sensing unit 232, a signal processing unit 233 and a control unit 234. A block 271 includes a first light emitting element 271a, a second light emitting element 271b and a third light emitting element 271c.

The switching unit 231 includes a first switch 231a, a second switch 231b and a third switch 231c. The first switch 231a controls a lighting time of the first light emitting element 271a in response to a first pulse signal. The second switch 231b controls a lighting time of the second light emitting element 271b in response to a second pulse signal. The third switch 231c controls a lighting time of the third light emitting element 271c in response to a third pulse signal. Illustratively, the first, second and third pulse signals are pulse width modulated signals.

The sensing unit 232 detects a light intensity of the first light emitting element 271a and outputs a first sensing signal. In addition, the sensing unit 232 detects a light intensity of the second light emitting element 271b and outputs a second sensing signal. Further, the sensing unit 232 detects a light intensity of the third light emitting element 271c and outputs a third sensing signal.

The signal processing unit 233 includes a first processor 233a, a second processor 233b and a third processor 233c. Illustratively, each of the first, second and third processor 233a, 233b and 233c includes a sample and hold (S/H) circuit that samples inputted signals and holds the sampled signals. For example, a first S/H circuit 233a samples and holds the first sensing signal to output a first light intensity signal having a first level, a second S/H circuit 233b samples and holds the second sensing signal to output a second light intensity signal having a second level, and a third S/H circuit 233c samples and holds the third sensing signal to output a third light intensity signal having a third level.

The control unit 234 controls operation of the block driver 230, so as to operate the block driver 230 in a driving mode or a correction mode or both.

In the driving mode, the control unit 234 supplies the first, second and third switches 231a, 231b and 231c with the first, second and third pulse signals to drive the first, second and third light emitting elements 271a, 271b and 271c. In the correction mode, the control unit 234 compares a respective first reference light intensity signal, a respective second reference light intensity signal and a respective third reference light intensity signal with corresponding first, second and third light intensity signals that are held and outputted by the first, second and third S/H circuits, and corrects any errors in the first, second and third light intensity signals. The control unit 234 generates a first corrected pulse signal, a second corrected pulse signal and a third corrected pulse signal corresponding to the first, second and third light intensity signals, respectively. Illustratively, the first, second and third reference light intensity signals may be pre-stored in the control unit 234. The first, second, and third reference light intensity signals include data specifying substantially white chromaticity coordinates.

The first, second and third corrected pulse signals generated by the control unit 234 are supplied to the first, second and third switches 231a, 231b and 231c, respectively, to control the lighting times of the first, second and third light emitting elements 271a, 271b and 271c. As a result, the first, second and third light emitting elements 271a, 271b and 271c are illuminated in response to the first, second and third corrected pulse signals to thereby generate substantially uniform white light.

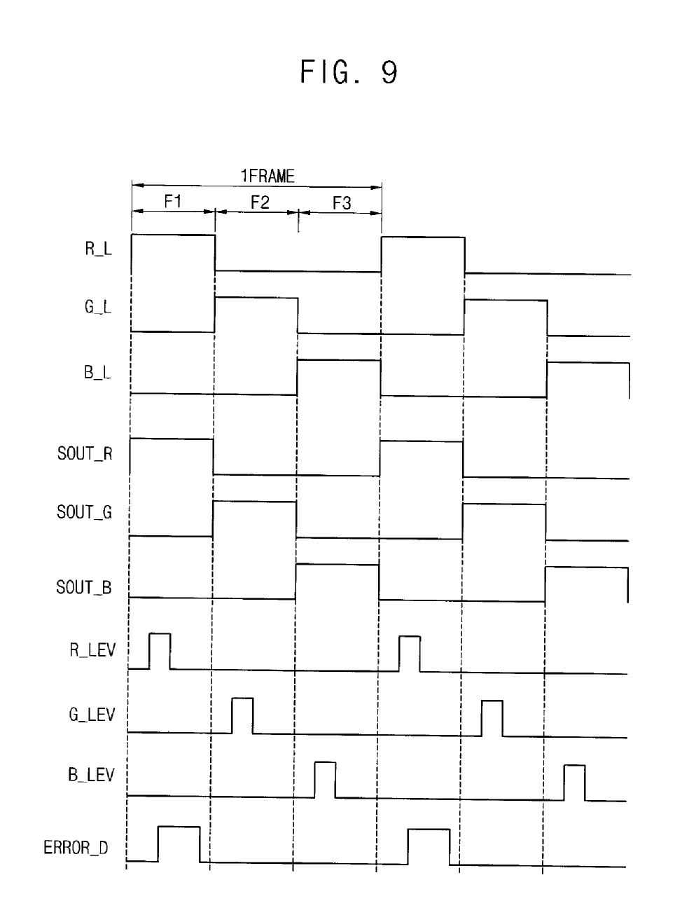

FIG. 9 is a timing diagram illustrating an exemplary operation performed by the block driver of FIG. 8. Referring to FIGS. 7A to 9, the control unit 234 (FIG. 8) supplies the first, second and third switches 231a, 231b and 231c with a first initial pulse signal PW1 (FIG. 7A), a second initial pulse signal PW2 (FIG. 7B), and a third initial pulse signal PW3 (FIG. 7C), respectively. The first, second and third switches 231a, 231b and 231c (FIG. 8) illuminate the first, second and third light emitting elements 271a, 271b and 271c in response to the first, second and third initial pulse signals PW1 (FIG. 7A), PW2 (FIG. 7B), and PW3 (FIG. 7C), respectively. The first light emitting element 271a (FIG. 8) projects a first light R_L (FIG. 9) during a first field F1, the second light emitting element 271b (FIG. 8) projects a second light G_L (FIG. 9) during a second field F2, and the third light emitting element 271c (FIG. 8) projects a third light B_L (FIG. 9) during a third field F3, during each of a plurality of time frames such as a first time frame 1FRAME.

The sensing unit 232 (FIG. 8) detects a light intensity of the first light R_L (FIG. 9) and outputs a first sensing signal SOUT_R during the first field F1. In addition, the sensing unit 232 (FIG. 8) detects a light intensity of the second light G_L (FIG. 9) during the second field F2 and outputs a second sensing signal SOUT_G. Further, the sensing unit 232 (FIG. 8) detects a light intensity of the third light B_L (FIG. 9) and outputs a third sensing signal SOUT_B.

The first S/H circuit 233a (FIG. 8) samples and holds the first sensing signal SOUT_R to output a first light intensity signal R_Lev having a first level, a second S/H circuit 233b samples and holds the second sensing signal SOUT_G to output a second light intensity signal G_Lev having a second level, and a third S/H circuit 233c samples and holds the third sensing signal SOUT_B to output a third light intensity signal B_Lev having a third level.

The control unit 234 (FIG. 8) corrects any errors in the first, second and third light intensity signals R_Lev, G_Lev and B_Lev (FIG. 9) as these light intensity signals are substantially simultaneously outputted from the first, second and third S/H circuits 233a, 233b and 233c (FIG. 8) during an error detecting period ERROR_D (FIG. 9). Illustratively, the control unit 234 (FIG. 8) compares the first, second and third light intensity signals R_Lev, G_Lev and B_Lev (FIG. 9) inputted into the control unit 234 (FIG. 8) with the first, second and third reference light intensity signals, respectively, that are pre-stored in the control unit 234, to obtain a first error value, a second error value and a third error value corresponding, respectively, to the first, second and third light intensity signals.

The control unit 234 generates a first corrected pulse signal PW_C1 (FIG. 7A), a second corrected pulse signal PW_C2 (FIG. 7B) and a third corrected pulse signal PW_C3 (FIG. 7C) each of which is corrected using the first, second and third error values, respectively, to output the first, second and third corrected pulse signals PW_C1 (FIG. 7A), PW_C2 (FIG. 7B), and PW_C3 (FIG. 7C) to the first, second and third switches 231a, 231b and 231c (FIG. 8), respectively. Thus, the first, second and third light emitting elements 271a, 271b and 271c will project a substantially uniform white light in response to the first, second and third corrected pulse signals PW_C1 (FIG. 7A), PW_C2 (FIG. 7B), and PW_C3 (FIG. 7C).

According to the present invention, a field sequential color display apparatus provides a substantially uniform white light by sensing and correcting light intensities of lights sequentially projected from a light emitting unit.

The foregoing is illustrative of the present invention and is not to be construed as limiting thereof. Although a few exemplary embodiments of the present invention have been described, those skilled in the art will readily appreciate that many modifications may be made with respect to the exemplary embodiments without materially departing from the novel teachings and advantages of the present invention. Accordingly, all such modifications are deemed to be included within the scope of the present invention as defined in the claims. In the claims, means-plus-function clauses are intended to cover not only the structures described herein as performing the recited function, but also functional equivalents and equivalent structures. Therefore, it is to be understood that the foregoing is illustrative of the present invention, and the present invention is not to be construed as limited to the specific exemplary embodiments disclosed herein. Many modifications can be made to the disclosed exemplary embodiments, and these as well as other exemplary embodiments, are intended to be included within the scope of the invention as set forth in the appended claims. The present invention is defined by the following claims, with equivalents of the claims to be included therein.

What is claimed is:

1. A device for driving a display backlight, the device sequentially driving each of a plurality of light emitting elements included in the backlight in accordance with one or more colors of light to be displayed, the device comprising:
a sensing unit that senses light intensities for each of a plurality of colors of light emitted by the light emitting elements, and outputs sensing signals for each of the plurality of colors of light emitted by the light emitting elements;
a signal processing unit that processes the outputted sensing signals to output light intensity signals having levels for each of the plurality of colors of light emitted by the light emitting elements; and
a control unit that controls the light emitting elements to generate a substantially uniform white light by outputting driving signals to the light emitting elements for each of the plurality of colors of light emitted by the light emitting elements, wherein the driving signals are based on at least one of the light intensity signals and a set of reference light intensity signals.

2. The device of claim 1, wherein the reference light intensity signals are pre-stored in accordance with the plurality of colors of light emitted by the light emitting elements in the control unit.

3. The device of claim 1, wherein the signal processing unit includes a low pass filter.

4. The device of claim 1, wherein the signal processing unit includes a sample and hold (S/H) circuit.

5. The device of claim 1, wherein the driving signals are pulse width modulated signals.

6. The device of claim 1, wherein the sensing unit comprises:
a first sensor configured to detect a light intensity of a first color of light to output a first sensing signal;
a second sensor configured to detect a light intensity of a second color of light to output a second sensing signal; and
a third sensor configured to detect a light intensity of a third color of light to output a third sensing signal.

7. The device of claim 6, wherein the first, second and third colors of lights comprise, respectively, red, green, and blue.

8. The device of claim 6, wherein the signal processing unit comprises:
a first filter that filters the first sensing signal to output a first light intensity signal;
a second filter that filters the second sensing signal to output a second light intensity signal; and
a third filter that filters the third sensing signal to output a third light intensity signal.

9. The device of claim 8, wherein the control unit outputs a first driving signal that is corrected using at least one of the first light intensity signal and a first reference light intensity signal,
wherein the control unit outputs a second driving signal that is corrected using at least one of the second light intensity signal and a second reference light intensity signal, and
wherein the control unit outputs a third driving signal that is corrected using at least one of the third light intensity signal and a third reference light intensity signal.

10. The device of claim of 9, wherein the control unit controls the light emitting elements to generate the first color of light during at least a portion of a first field, the second color of light during at least a portion of a second field, and the third color light during at least a portion of a third field, and wherein the first, second, and third fields are all within a first frame.

11. The device of claim of 10, wherein the control unit generates respective first, second and third corrected driving signals based on corresponding first, second and third light intensity signals during the first field, and based on corresponding first, second and third reference light intensity signals during the first field.

12. A method for driving a display backlight having a plurality of light emitting elements that are sequentially driven in accordance with one or more colors of light to be displayed, the method comprising:
sensing light intensities for each of a plurality of colors of light emitted by the light emitting elements to output sensing signals for each of the plurality of colors of light emitted by the light emitting elements;
processing the outputted sensing signals to output light intensity signals having levels for each of the plurality of colors of light emitted by the light emitting elements; and
controlling the light emitting elements to generate a uniform white light using at least one of the light intensity signals and a set of reference light intensity signals.

13. The method of claim 12, wherein the reference light intensity signals are pre-stored in accordance with the plurality of colors of light emitted by the light emitting elements in the control unit.

14. The method of claim of 13, wherein the plurality of colors include a first color of light emitted during a first field, a second color of light emitted during a second field, and a third color of light emitted during a third field, and wherein the first, second and third fields are included within one frame.

15. The method of claim of 14, wherein sensing light intensities for each of a plurality of colors of light emitted by the light emitting elements to output sensing signals for each of the plurality of colors of light comprises:
sensing a light intensity of the first color of light to output a first sensing signal;
sensing a light intensity of the second color of light to output a second sensing signal; and
sensing a light intensity of the third color of light to output a third sensing signal.

16. The method of claim of 15, wherein processing the outputted sensing signals to output light intensity signals comprises at least one of:
processing the first sensing signal to output a first light intensity signal;
processing the second sensing signal to output a second light intensity signal; or
processing the third sensing signal to output a third light intensity signal.

17. The method of claim of 12, wherein controlling the light emitting elements comprises:
generating driving signals that are corrected using at least one of: (a) the light intensity signals and (b) the reference light intensity signals; and
outputting the corrected driving signals to the light emitting elements.

18. A display apparatus comprising:
a liquid crystal display (LCD) panel that displays an image;
a display backlight including a plurality of light emitting elements that emits a plurality of colors of light; and
a display backlight driver that sequentially drives the plurality of light emitting elements in accordance with each of the plurality of colors of light, and detects light intensities of the light emitting elements in accordance with each of the plurality of colors of light to control the light emitting elements such that the light emitting elements generate a substantially uniform white light.

19. The display apparatus of claim of 18, wherein the display backlight driver comprises:
a sensing unit that senses light intensities of the colors of light generated by the light emitting elements in accordance with each of the plurality of colors of light, and outputting sensing signals in accordance with each of the plurality of colors of light;
a signal processing unit that processes the outputted sensing signals to output light intensity signals having corresponding levels for each of the plurality of colors of light; and
a control unit that controls the light emitting elements to generate a substantially uniform white light using at least one of the light intensity signals and a set of reference light intensity signals, the reference light intensity signals being pre-stored in accordance with the colors of light generated by the light emitting elements.

20. The display apparatus of claim 19, wherein the signal processing unit comprises a low pass filter.

21. The display apparatus of claim 19, wherein the signal processing unit comprises a sample and hold (S/H) circuit.

22. The display apparatus of claim 19, wherein the display backlight generates a first color of light during a first field, a second color of light during a second field, and a third color of light during a third field, wherein the first, second, and third fields are all within a single frame, and wherein the control unit generates a first driving signal, a second driving signal and a third driving signal that are corrected using, respectively, a first light intensity signal, a second light intensity signal and a third light intensity signal, and using, respectively, a first reference light intensity signal, a second reference light intensity signal and a third reference light intensity signal.
